(19) United States
(12) Patent Application Publication
(10) Pub. No.: US 2016/0162703 A1
(43) Pub. Date: Jun. 9, 2016

(54) SYSTEM AND METHOD FOR PROCESSING DOCUMENTS

(71) Applicant: AGFA HEALTHCARE, Bonn (DE)

(72) Inventor: Michael KAUFMANN, Mortsel (BE)

(21) Appl. No.: 14/903,857

(22) PCT Filed: Aug. 26, 2014
(86) PCT No.: PCT/EP2014/068020

§ 371 Date: Jan. 8, 2016

(30) Foreign Application Priority Data
Aug. 27, 2013 (EP) 13181804.9

(51) Int. Cl. G06F 21/62; G06F 21/64; G06F 17/30

(52) U.S. Cl. CPC G06F 21/6245; G06F 21/6218; G06F 17/30011; G06F 21/64

(57) ABSTRACT

A system and method for processing documents includes a first component for receiving document data of at least one document, authenticating a user and storing the received document data of the at least one document in a database when the authenticated user corresponds with a pre-specified or entitled user; a second component for receiving document data of at least one document, generating at least one document in a portable document format based on the received document data, authenticating a user, digitally signing and/or encrypting the at least one generated document in the portable document format, and storing the at least one digitally signed and/or encrypted document in the portable document format in a database when the authenticated user corresponds with a pre-specified or entitled user; and a third component for deciding whether the at least one document shall be processed either in the first component or in the second component.

### CROSS-REFERENCE TO RELATED APPLICATIONS

This application is a 371 National Stage Application of PCT/EP2014/068020, filed Aug. 26, 2014. This application claims the benefit of European Application No. 13181804.9, filed Aug. 27, 2013, which is incorporated by reference herein in its entirety.

### BACKGROUND OF THE INVENTION

1. Field of the Invention

The invention relates to a system and a method for processing documents.

2. Description of the Related Art

Document management systems (DMS) in medical applications, like electronic health records in hospital information systems (HIS), usually have rights management modules that allow an administrator to give read and/or write access to documents of a certain type to only certain users or groups of users. Document signing is a possible way to preclude alteration or unintended use of a document. Accordingly, some document management systems provide the ability to sign documents electronically within separated workflows. However, implementing and using e-signatures is complex, in particular in view of the variety of national compliance requirements, health care IT standards, particular regulatory environment as well as different available technologies and techniques.

### SUMMARY OF THE INVENTION

Preferred embodiments of the invention provide a system and an according method for processing documents which is easily and reliably adaptable to various requirements, in particular without interruption of or interference with existing workflows.

The advantages and benefits are achieved by the system and method described below.

The system for processing documents according to a preferred embodiment of the invention preferably comprises a single module containing three separated process-related components. A first component is designed for receiving document data of at least one document, authenticating a user, and storing the received document data of the at least one document in a database in the case that the authenticated user corresponds with a pre-specified or entitled user. It further comprises a second component designed for receiving document data of at least one document, generating at least one document in a portable document format based on the received document data, authenticating a user, digitally signing and/or encrypting the at least one generated document, and storing the at least one digitally signed and/or encrypted document in the portable document format in a database in the case that the authenticated user corresponds with a pre-specified or entitled user. The system further comprises a third component designed for deciding whether the at least one document shall be processed either in the first component or in the second component.

The method for processing documents according to a preferred embodiment of the invention comprises receiving document data of at least one document and deciding whether the at least one document shall be processed either in a first component or in a second component. In the case that the at least one document shall be processed in the first component, the following steps are effected: authenticating a user and storing the received document data of the at least one document in a database in the case that the authenticated user corresponds with a pre-specified or entitled user. In the case that the at least one document shall be processed in the second component, the following steps are effected: generating at least one document in a portable document format based on the received document data of the at least one document, authenticating a user, digitally signing and/or encrypting the at least one generated document in the portable document format, and storing the digitally signed and/or encrypted document in the portable document format in a database in the case that the authenticated user corresponds with a pre-specified or entitled user.

Preferred embodiments of the invention are based on the approach to provide selectable alternatives of a first (“standard”) authentication with optional PDF document generation but without digital signature and/or encryption in a first component and a second (“extended”) authentication with mandatory PDF document generation with digital signature and/or encryption of the PDF document in a second component. By this, a, preferably configurable, integration of a software module is designed for an extended authentication and digital document signing and/or encryption into existing document workflows comprising a standard authentication with/without digital signature and/or encryption within a HIS without changing, interrupting or interfering with such existing workflows.

Preferably, the system is designed such that the integration of the software component can be configured by an administrator and optionally activated on the basis of system settings. In this respect, it is particularly preferred that only an administrator of the system but not the users, like physicians, nurses, kitchen or administrative staff, shall be allowed to configure the system and how a document shall be processed, i.e. by the standard user authentication with optional PDF document generation or by the extended user authentication with mandatory PDF document generation and digital signature and/or encryption of the PDF document.

It is further preferred that in addition to several configurable settings for authentication, signing and encryption, a selection of documents to be affected based on a configuration by the administrator is available. The configurations may include, e.g., settings that relate to both the time of signing as well as the selection of the documents concerned.

Moreover, the aforementioned integration of the digital signing and/or encryption software module is not limited to the functionalities of PDF document creation and signing/encryption within already existing electronic document workflows without encryption or signing. Rather, by activating the digital signing and/or encryption software component, automated processes of the document workflow (e.g. stack attestation and offline PDF creation) are preferably replaced by interactive processes; moreover, processes for PDF document creation and signing are, preferably always, executed together. As a result, the already available standard workflow or the extended workflow including digital document encryption and signing are executed dependent upon respective HIS settings.

In summary, the processing of documents can be easily and reliably adapted to various legal as well as technical requirements without interfering with or interrupting existing document workflows.

The term “component” preferably relates to a part of a computer-implemented preferred embodiment of a technical procedure, apparatus or system. Preferably, a component can interact with other parts, i.e. components, of a computer-implemented preferred embodiment of a technical procedure, apparatus or system.

The term “document” preferably relates to a singular instance (i.e. a singleton of an object-oriented computer programming language, like Java™) which is described by a definition of a form. A definition of a form describes user-editable and calculated contents, applicable guidelines, available functionalities and workflows within a HIS framework. Available functions may include, e.g., printing, signing or a simple saving of a document. Form definitions can preferably be created by the manufacturer of the respective modules and/or by authorized persons, in particular administrators of a HIS in which the system or method is implemented.

The term “portable document format” (PDF) preferably relates to a file format for representing a document independently of application software, hardware and operating systems. In particular, a PDF file of a document encapsulates a complete description of a fixed-layout document based on the document data, including text, fonts, graphics and other information needed to display it.

The term “authentication” preferably relates to a process of verifying a user's identity. This can be achieved, e.g., by validating a user's ID card and/or user ID and/or password.

The term “pre-specified or entitled user” preferably relates to one or more users who are specified before the workflow of processing a document is executed.

The terms “digitally signing” and “digital signature” preferably relate to a cryptographic signature, (in particular by a digital key) that authenticates the signing user and ensures document integrity. By digitally signing a document the document is protected by a type of tamper-proof seal that breaks if the document's content were to be altered.

The terms “encrypting” or “encryption” of a document preferably relates to a process of transforming the contents of the document, in particular the document data, into an unintelligible string of characters that can be stored in a database or transmitted via communications media with a high degree of security and may then be decrypted.

Preferably, the third component is integrated in the second component. In particular, an according decision step as to whether the document shall be processed in the first or second component is integrated in the second component, wherein in the latter case (processing in second component) the already started process in the second component is continued, whereas in the former case (processing in first component) the already started process in the second component branches to a step of the first component so that the document processing is continued in the first component. By this, the functionalities of the system can be easily and reliably extended, in particular adapted, by adding the second component and simply linking same to the first component without the need for a modification of the first component. Accordingly, the existing workflow carried out by the first component does not have to be changed or interrupted nor is there any adverse interference due to the provision of the second component and its workflow.

According to another preferred aspect of the invention, the third component is configured such that the decision whether the document data shall be processed in the first component or in the second component is effected after the document data have been received in the second component. In this way, in the decision (i.e. first or second component) the type and/or content of the document to be processed can be considered. For example, the system is designed such that an administrator can specify in advance whether a document of a specific type and/or with a pre-specified content shall be processed in the first or second component. This further extends the system's adaptability to various requirements in a reliable and simple way.

It is, moreover, preferred that the third component is configurable such that the decision whether the document data shall be processed in the first component or in the second component is pre-specifiable, i.e. specifiable before document processing is started in the first and/or second component. In particular, the system is configured such that only a system administrator, but in particular not a system user, shall be allowed to accordingly specify the system by choosing respective system settings. By this, the mode of operation of the system can be simply and reliably pre-specified in consideration of the specific requirements of any concrete application.

According to yet another preferred preferred embodiment, the second component is configured such that the received document data of the at least one document are stored in a database in the case that the authenticated user corresponds with a pre-specified or entitled user. Preferably, a user can be pre-specified or entitled in the system settings and/or in the document data of the document. Accordingly, in the case that the identity of a current user is verified in an authentication step and the authenticated user is identical with the user pre-specified or entitled in the system settings and/or settings in the current document the document data of the document are stored in the database.

Preferably, the first component is configured for generating at least one document in a portable document format based on the received document data. Additionally or alternatively, the first component is configurable by pre-specifying whether at least one document in a portable document format based on the received document data shall be generated or not. By at least one of these preferred embodiments, the system becomes easily and reliably adaptable to various requirements also with respect to functionalities of the first component.

The first component and/or second component is preferably configured for displaying a preview, in particular a print preview, of the at least one document based on the received document data. Within the meaning of the present invention, a print preview relates to a representation of the document data on a display device, wherein the representation of the document data on the display is identical to the representation of the document data in a printout of a printing device. In this way it is ensured that the later representation of the document data in a printout and/or in another fixed-layout document format, like a portable document format, can be examined by the current user before the document is printed or converted, respectively. In particular, the first component and/or second component can be configured such that at least one document in a portable document format based on the received document data is generated only in the case that the preview, in particular the print preview, of the at least one document based on the received document data is displayed. Hereby it is ensured that the current user is given the opportunity to verify the layout of the document in the printout and/or portable data format before the document is printed or converted, respectively.

According yet another advantageous preferred embodiment of the invention, the first component and/or second component are configured such that in the case that document data of two or more documents are received, an authentication of the user is effected in a stack mode or in a single mode, wherein in the stack mode an authentication of the user is effected for only one document of the at least two documents, and wherein in the single mode an authentication of the user is effected for each of the documents of the received document data. Preferably, the first component and/or second component are configurable by pre-specifying whether an authentication of the user is effected in the stack mode or in the single mode. For example, the authentication mode (i.e. stack mode or single mode) can be pre-specified by respective settings in the first and/or second component and/or by respective settings in at least one of the two or more documents to be processed. By this, the mode of operation of the system can be simply and reliably pre-specified in consideration of the specific requirements of any concrete application.

According to further preferred preferred embodiments of the invention, the system and/or the first component and/or the second component and/or the third component is/are configurable by pre-specifying one or more of the following: whether a document is allowed to be signed and/or encrypted, whether a document has to be signed and/or encrypted, one or more users being authorized to sign and/or encrypt a document, a point in time when signature and/or encryption of a document is effected. Preferably, the mentioned criteria can be pre-specified by respective settings in the system or component(s) or by respective settings in at least one of the two or more documents to be processed. By at least one of these preferred embodiments, the adaptability of the system and method to various, including technical, requirements is further improved.

Further advantages, features and examples of the present invention will be apparent from the following description of following figures.

### BRIEF DESCRIPTION OF THE DRAWINGS

FIG. 1 shows a flowchart of an example of a first document processing workflow in a first component; and

FIG. 2 shows a flowchart of an example of a second document processing workflow in a second component.

### DETAILED DESCRIPTION OF THE PREFERRED PREFERRED EMBODIMENTS

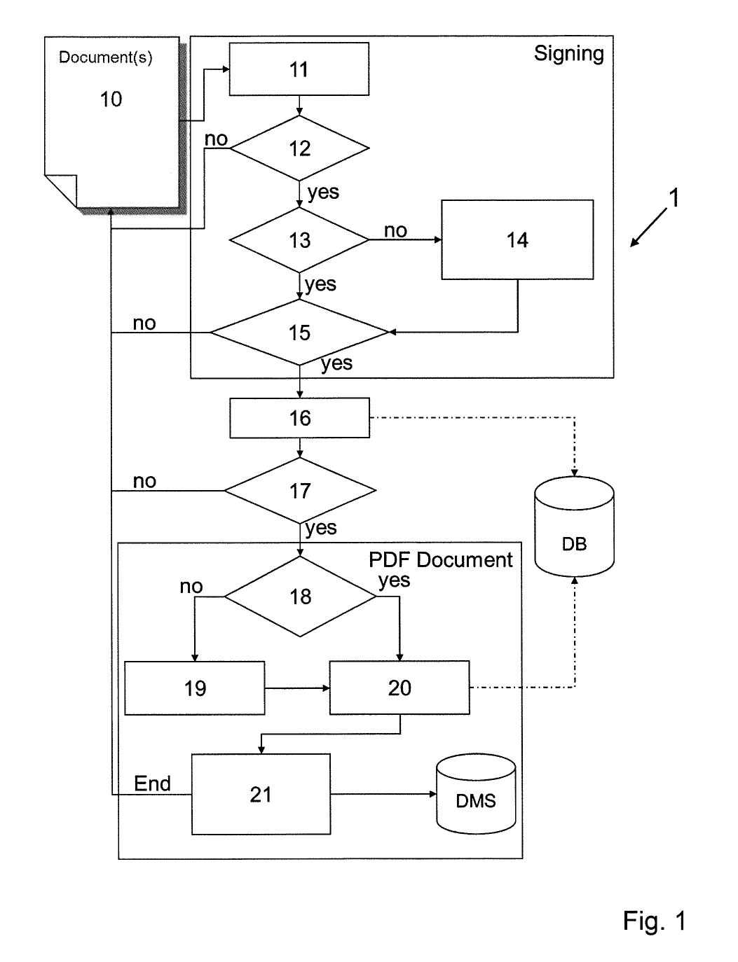

FIG. 1 shows a flowchart of an example of a first document processing workflow, in the following also called “standard process”, in a first component 1 of the system. Preferably, the standard process includes a non-digital document signing. Moreover, a subsequent creation of a PDF document is optional and may be configured by custom system settings.

The first process is started automatically or by user interaction in an open document 10. This is followed by a content-related validation (step 11) of the document or the corresponding document data and an optional interactive confirmation (step 12) of the results of the validation by the user. In the negative case where the results of the validation are not confirmed by the user, the first process is aborted. In the positive case where the results of the validation are confirmed by the user, it is determined (step 13) whether the user performs signing in a so-called stack mode, wherein each document of a stack, i.e. a number of documents, is signed by the same user.

In the positive case, i.e. in the stack mode, a user authentication is checked (step 14) only for the first document of the stack. In the negative case, i.e. in a single-document mode, the user authentication is checked (step 14) for each of the documents.

Thereupon, it is checked (step 15) whether the authenticated user is confirmed by a definable set of rules in the document. In the negative case, the process is restarted and can be interactively stopped by the user. In the positive case, the entire document content is stored (step 16) in a database DB.

Subsequently, it is checked (step 17) whether the system is configured such that, additionally to the storage of the document data in the database DB, a PDF document shall be created.

In the positive case, the process of PDF document creation is started, which begins with an examination (step 18) of whether the document is already in a print preview. In the negative case, the document will be displayed (step 19) in the print preview.

In the positive case or after switching to the print preview (step 19), respectively, a PDF document is created (step 20), which will be subsequently archived (step 21) in an available document management system DMS.

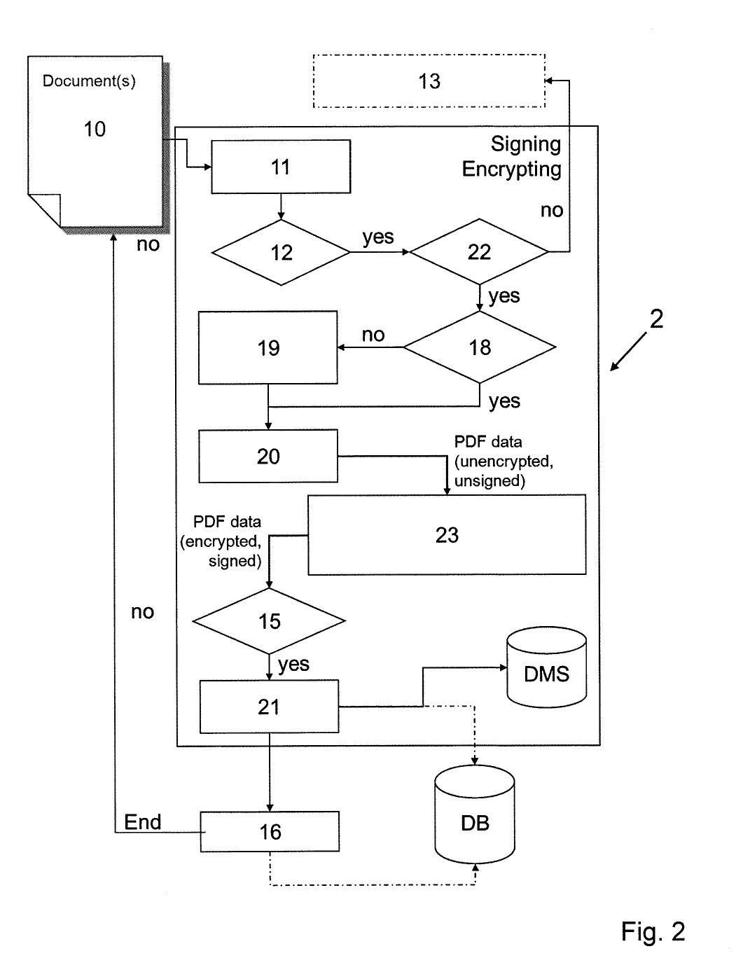

FIG. 2 shows a flowchart of an example of a second document processing workflow, in the following also called “extended process”, in a second component 2 of the system. Preferably, the extended process includes a mandatory creation of a PDF document and a digital signing and/or encryption of the created PDF document.

Like with the standard process elucidated above, the extended process is started automatically or by user interaction when a document 10 is open.

After a content-related validation of the document (step 11) an optionally interactive confirmation of the results (step 12) of the validation follows. In the negative case, the process is aborted. In the positive case where the validation of the document is confirmed, it is decided (step 22) whether the processing of the document 10 is continued in the extended process (positive case) in the second component 2 or in the standard process (negative case) in the first component 1. In the negative case, the processing of the document 10 is continued at step 13 (i.e. decision whether signing shall be carried out in stack mode) of the standard process (see FIG. 1).

In the context of the present invention, step 22 may also be regarded as a third component 22 which is configured for deciding whether the at least one document 10 shall be processed either in the first component 1 (see FIG. 1) or in the second component 2. In the example given in FIG. 2, the third component 22 is integrated in the second component 2. Alternatively, the third component 22 can be a separate component, wherein a decision whether a document shall be processed in the first component 1 or in the second component 2 is preferably already taken before the first step 11 in the first component 1 or second component 2 is executed.

If it is decided in step 22 that the processing of the document 10 shall continue in the extended process (positive case) in the second component 2, a process of PDF document creation is started, which begins with an examination (step 18) whether the document is already displayed in a print preview.

In the negative case, the document 10 is displayed (step 19) in the print preview. In the positive case or after switching to the print version, respectively, a PDF document based on the document data of document 10 is created (step 20).

Thereupon, the unencrypted and unsigned data of the generated PDF document are forwarded to a signature/encryption component which is designed for authenticating the user and, preferably interactively, digitally signing and encrypting the generated PDF document (step 23).

Next, the authenticated user has to be confirmed (step 15) by a pre-configurable set of rules in the document. In the negative case, the process is restarted and can be stopped by the user interactively. In the positive case, the digitally signed and encrypted PDF document is archived (step 21) in a document management system DMS and the complete content of the original document 10 is saved (step 16) in a database DB.

1-10. (canceled)

11. A system for processing documents comprising:
a first component configured or programmed to:
receive document data of at least one document;
authenticate a user; and
store the received document data of the at least one document in a database in a case that the authenticated user corresponds with a pre-specified or entitled user;
a second component configured or programmed to:
receive document data of at least one document;
generate at least one document in a portable document format based on the received document data;
authenticate a user;
digitally sign and/or encrypt the at least one generated document in the portable document format; and
store the at least one digitally signed and/or encrypted document in the portable document format in a database in a case that the authenticated user corresponds with a pre-specified or entitled user; and
a third component configured or programmed to decide whether to process the at least one document either in the first component or in the second component.

12. The system according to claim 11, wherein the first component is linked to the second component;
the third component is integrated in the second component such that, in a case of a decision to process the at least one document in the second component, an already started process in the second component is continued; and
in a case of a decision to process the at least one document in the first component, the already started process in the second component branches to a step executed by the first component so that the document processing is continued in the first component.

13. The system according to claim 11, wherein the third component is configured or programmed to decide whether to process the document data in the first component or in the second component after the document data have been received in the second component.

14. The system according to claim 11, wherein the third component is configured or programmed such that the decision whether to process the document data the first component or in the second component is pre-specified.

15. The system according to claim 11, wherein the second component is configured or programmed such that the received document data of the at least one document are stored in a database in the case that the authenticated user corresponds with the pre-specified or entitled user.

16. The system according to claim 11, wherein the first component is configured or programmed to generate at least one document in a portable document format based on the received document data.

17. The system according to claim 11, wherein the first component and/or the second component is configured or programmed to display a preview of the at least one document based on the received document data.

18. The system according to claim 11, wherein the first component and/or the second component is configured or programmed such that, in a case that document data of two or more documents are received, an authentication of the user is effected in a stack mode or in a single mode;
in the stack mode, an authentication of the user is effected for only one document of the at least two documents; and
in the single mode, an authentication of the user is effected for each of the documents of the received document data.

19. The system according to claim 11, wherein the system, the first component, the second component, and/or the third component are configured by pre-specifying one or more of the following:
whether a document is allowed to be signed and/or encrypted;
whether a document has to be signed and/or encrypted;
one or more users are authorized to sign and/or encrypt a document; and
a point in time when signature and/or encryption of a document is effected.

20. A method for processing documents comprising the steps of:
receiving document data of at least one document;
deciding whether to process the at least one document either in a first component or in a second component;
if the at least one document is to be processed in the first component:
authenticating a user; and
storing the received document data of the at least one document in a database in a case that the authenticated user corresponds with a pre-specified or entitled user;
if the at least one document is to be processed in the second component:
generating at least one document in a portable document format based on the received document data of the at least one document;
authenticating a user;
digitally signing and/or encrypting the at least one generated document in the portable document format; and
storing the digitally signed and/or encrypted document in the portable document format in a database in the case that the authenticated user corresponds with the pre-specified or entitled user.
